(19) United States
(12) Patent Application Publication
(10) Pub. No.: US 2016/0149989 A1
(43) Pub. Date: May 26, 2016

(54) METHOD FOR TRANSFERRING DATA BETWEEN AN ELECTRICAL MEASURING DEVICE AND A CONTROL COMPUTER

(71) Applicant: Bender GmbH & Co. KG, Gruenberg (DE)

(72) Inventors: Markus Kremer, Gruenberg (DE); Daniel Schmidt, Gruenberg (DE)

(21) Appl. No.: 14/945,509

(22) Filed: Nov. 19, 2015

(30) Foreign Application Priority Data
Nov. 20, 2014 (DE) 10 2014 223 717.3

(51) Int. Cl. H04L 29/08

(52) U.S. Cl. CPC H04L 67/02; H04L 67/32

(57) ABSTRACT

The invention relates to a method for transferring data between an electrical measuring device (2) and a control computer (4), the data being transferred via a Modbus protocol (20) that is tunneled in the HTTP protocol (12) in connection with a TCP/IP transmission protocol (14).

The principle idea of the present invention is based on HTTP (12) being used as an external protocol and a Modbus protocol (20) being integrated, i.e. tunneled, into the HTTP protocol (12) as payload.

The disclosure of German Patent Application Ser. No. 10 2014 223 717.3 is incorporated herein by reference.

### TECHNICAL FIELD

The invention relates to a method for transferring data between an electrical measuring device and a control computer, the data being transferred via an HTTP protocol and via a TCP/IP transmission protocol.

### BACKGROUND

In electrical measuring devices, it is common according to the state of the art to equip the measuring devices with a corresponding communication interface in order to transfer measured values and to parameterize the measuring devices.

In the course of increasing integration of electrical equipment into superior control processes and the accompanying growing formation of networks, many of these measuring devices have an Ethernet or wireless interface that is used by a transfer protocol belonging to the TCP/IP protocol family.

The term measuring device relates in particular to electrical devices that are integrated as embedded systems into a greater electrical or mechanical system and there, usually based on microprocessors, perform a specific measuring task.

On the application level, there are special communication protocols that are characterized by flexibility and simplicity of implementation, thus being especially suitable for embedded systems. A known and resource-friendly transfer protocol is the Modbus protocol. In its operating variant Modbus TCP, the Modbus protocol uses the TCP/IP protocol family as transport-oriented transfer protocols. The Modbus protocol is a stand-alone communication protocol that is based on server/client architecture. To process and display the transferred data, software specific to measuring devices (application software) must be installed on the user's control computer.

Some modern measuring devices, in particular some embedded systems, additionally support the HTTP protocol so as to allow the user to access the measuring device via a web browser. In this case, installation of measuring device-specific software on the control computer may be omitted. On the measuring device, a webserver is implemented that comprises processing logic for the data transferred via HTTP protocol.

If the measuring device also supports the HTTP protocol in addition to the Modbus protocol, a data value generated in the measuring device has to be converted into several different message units that correspond to the respective transfer protocol. The measuring device must also be capable of decoding the received messages, which are different depending on the transfer protocol used.

As regards disadvantages of the known methods, it thus is be noted that separate processing logic has to be implemented in the measuring device for each application-oriented transfer protocol used, said processing logic being configured to the data model of the measuring device for value query or for parameterization and generating the respective message units and message sequences according to the protocol. This leads to redundancies, which consume memory and computing resources, which is undesired in particular in view of implementation in embedded systems, which have limited memory and computing capacity. Moreover, multiple implementations constitute additional sources of errors.

Therefore, the present invention is based on the object of proposing a method for transferring data between an electrical measuring device and a control computer that requires less memory and computing resources on the measuring device as compared to the transfer methods known from the state of the art.

### SUMMARY

This object is attained in connection with the preamble of claim 1 in that the data is transferred via a Modbus protocol that is tunneled in the HTTP protocol.

The principle idea of the present invention is based on HTTP being used as an external protocol and a Modbus protocol being integrated, i.e. tunneled, into the HTTP protocol as payload. By using the tunneled Modbus protocol, it is no longer necessary to implement processing logic in the measuring device that maps the data of the data model of the measuring device into corresponding HTTP messages or that generates corresponding data from the received HTTP messages. The interface to the data model is formed solely by the Modbus protocol implemented in the measuring device or by the Modbus driver implementing the Modbus protocol.

With this protocol structure, less memory and computing resources are required on the measuring device as compared to a parallel implementation of multiple application-oriented protocols because in particular the processing steps for the value query or parameterization per HTTP do no longer have to be implemented.

In another advantageous embodiment, the HTTP protocol is executed on the measuring device by a webserver that is installed on the measuring device and that has a minimum range of functions.

The HTTP protocol is processed on the measuring device by a webserver installed on the measuring device. For this purpose, it is sufficient for the webserver to comprise only a resource-friendly subset of the range of functions of a webserver common in the state of the art.

In a preferred embodiment, the tunneled Modbus protocol is processed on the measuring device by complete Modbus protocol implementation.

Only the implementation of the resource-friendly Modbus protocol is required on the measuring device as the sole interface to the data model internal to the measuring device. Processing logic for the value query or parameterization via HTTP is unnecessary because the data is transferred in a tunneled manner in the form of Modbus messages.

In another embodiment, the transferred data is conditioned and processed in a web browser by a web application, the web browser being installed on the control computer.

A web application executed in a web browser forms the basis for processing and display of the transferred data on the control computer. The web application communicates with the measuring device via the tunneled Modbus protocol.

Furthermore, the web application is stored in a non-volatile memory on the measuring device and is loaded to the control computer on demand.

If the user wants to access the measuring device, they can download the web application stored on the measuring device into their web browser by entering the IP address of the measuring device in the web browser of the control computer.

Alternatively, a download page that contains a link to a website from which the web application is loaded to the control computer on demand is preferably stored in a non-volatile memory on the measuring device.

Thus, it is possible to save FLASH resources because the web application is downloaded from an internet address instead of being stored on the measuring device. For this purpose, each measuring device firmware has a distinct identifier according to which the matching web application is downloaded to the control computer. On the measuring device, only a website requiring little storage space is stored, via which the actual web application is subsequently loaded from an internet address to the control computer. When using additional web resources, it is also conceivable to extend measuring device features by dynamic loading. The web application may be updated without having to update the measuring device firmware.

In another embodiment, port 502, which is reserved for the Modbus protocol, is used for the HTTP protocol.

Additional storage space may be saved in connection with the network drivers (here: ports) by also using port 502, which is usually reserved for the Modbus application, for HTTP transfer. In this course, the minimally equipped webserver is completely integrated into the Modbus driver.

### BRIEF DESCRIPTION OF THE DRAWING FIGURES

Other advantageous embodiment features become apparent from the following description and from the drawings, which show a preferred embodiment of the invention with the aid of examples. In the figures:

FIG. 1: shows a data transfer according to the state of the art,

FIG. 2: shows a data transfer according to the invention, and

FIG. 3: shows a data transfer according to the invention including an internet connection.

The following figures show block diagrams illustrating the functional components of a data transfer between a measuring device 2 and a control computer 4 on which the methods known according to the state of the art and the methods claimed are based.

### DETAILED DESCRIPTION

FIG. 1 shows a functional block diagram of the communication between the measuring device 2 and the control computer 4. To read out the data 6 available on the measuring device 2 and to configure the measuring device parameters 8, the control computer 4 communicates with the measuring device 2 by means of a web browser 10 via the protocol HTTP 12 and a TCP/IP connection 14. While doing so, the web browser 10 constantly requests new websites, which are continuously recalculated in a webserver 16, which is installed on the measuring device 2, based on the data received from the control computer 4 and stored in the measuring device 2 and which are sent to the control computer 4.

Optionally, a Modbus communication 20 may be provided which is separate from the HTTP and TCP/IP connections 12, 14 and for whose function a Modbus driver 22 must be installed on the measuring device 2, said Modbus driver 22 in turn requiring additional storage space. On the control computer 4, Modbus application software 24 is necessary, which may be loaded from an installation medium or from a website if an internet connection is available.

Both the Modbus driver 22 and the webserver 16 have to be familiar with and be able to process the data model 6, 8 of the measuring device 2.

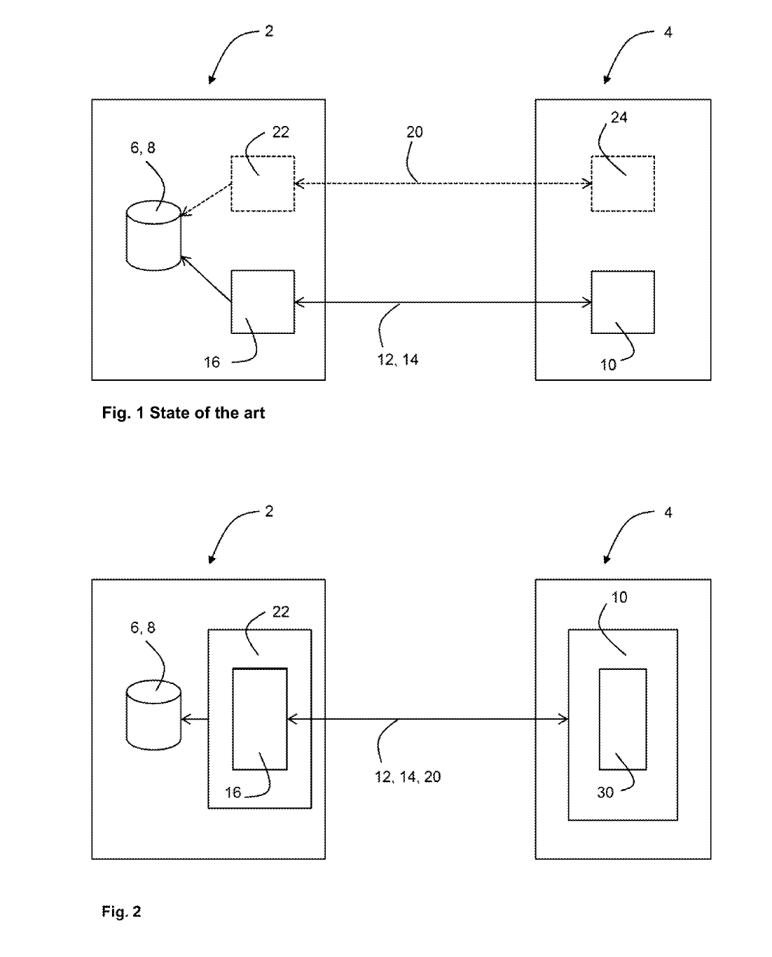

In FIG. 2, a functional block diagram of the data transfer according to the invention between the measuring device 2 and the control computer 4 is illustrated.

A web application 30 forms the core of the method, said web application 30 being executed on a web browser 10 that is installed on the control computer 4.

Communication takes place via the HTTP and TCP/IP connection 12, 14, the Modbus protocol 20 being integrated as a tunnel in the HTTP protocol 12.

A webserver 16 with a minimum range of functions is realized on the side of the measuring device 2. The interface to the data model 6, 8 of the measuring device 2 is formed solely by the Modbus driver 22, the Modbus messages 20 received via HTTP 12 being processed directly.

Once the web application 30 has been loaded from the web server 16 of the measuring device 2 by means of the web browser 10 via the HTTP and TCP/IP connection 12, 14, the measured data 6 and the parameters 8 may be transferred as payload via the Modbus protocol 20 tunneled in the HTTP protocol 12.

The measured data and the parameters 8 integrated as Modbus messages 20 are visualized and conditioned in the web browser 10.

By tunneling the Modbus protocol 20, a significant reduction of the required storage and of the computing load in the measuring device 2 is achieved.

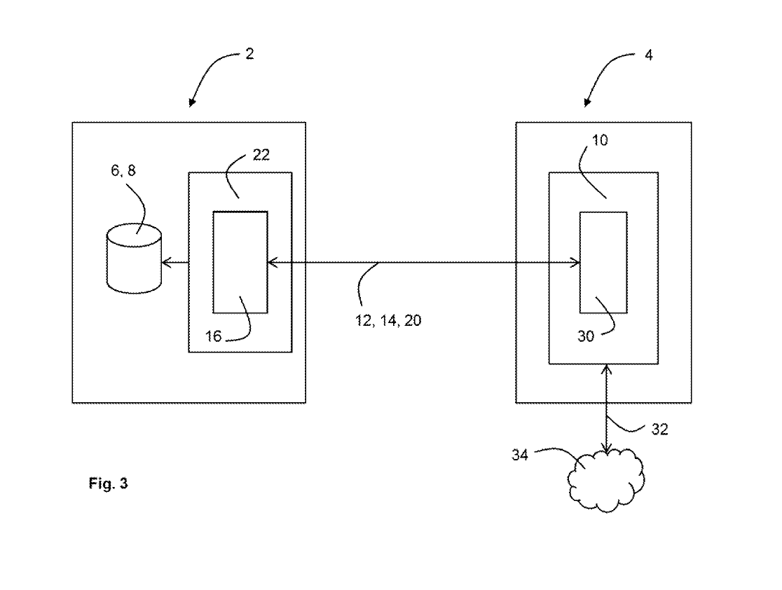

In FIG. 3, the data transfer according to the invention of FIG. 2 has been extended by an internet connection 32 of the control computer 4. In this constellation, the code of the web application 30 is not stored in a memory of the measuring device 2, but is loaded onto the control computer 4 from an internet server 34 via the internet connection 32. Only a loading page is stored on the measuring device 2, which loads the actual web application 30 from the internet server 34 upon transfer to the control computer 4.

1. A method for transferring data between an electrical measuring device (2) and a control computer (4), the data being transferred via an HTTP protocol (12) and via a TCP/IP transmission protocol (14),
characterized in that
the data is transferred via a Modbus protocol (20) that is tunneled in the HTTP protocol (12), Modbus messages (20) being integrated directly into the HTTP protocol as payload without implementing processing logic for mapping data into HTTP messages.

2. The data transfer method according to claim 1,
characterized in that
the HTTP protocol (12) is executed on the measuring device (2) by a webserver (16) that is installed on the measuring device (2) and that has a minimum range of functions.

3. The data transfer method according to claim 1,
characterized in that
the tunneled Modbus protocol (20) is processed on the measuring device (2) by complete Modbus protocol implementation (22).

4. The data transfer method according to claim 1,
characterized in that
the transferred data is conditioned and processed in a web browser (10) by a web application (30), the web browser being installed on the control computer (4).

5. The data transfer method according to claim 1,
characterized in that
the web application (30) is stored in a non-volatile memory on the measuring device (2) and is loaded to the control computer (4) on demand.

6. The data transfer method according to claim 1,
characterized in that
a loading page that contains a link to a website from which the web application (30) is loaded to the control computer (4) on demand is stored in a non-volatile memory on the measuring device (2).

7. The data transfer method according to claim 1,
characterized in that
port 502, which is reserved for the Modbus protocol (20), is used for the HTTP protocol (12).
